(19) United States
(12) Patent Application Publication
(10) Pub. No.: US 2025/0254247 A1
(43) Pub. Date: Aug. 7, 2025

(54) IMAGE FORMING APPARATUS, CONTROL METHOD, AND STORAGE MEDIUM

(71) Applicant: CANON KABUSHIKI KAISHA, Tokyo (JP)

(72) Inventors: JUN HORIYAMA, Tokyo (JP); NATSUMI IKEGAWA, Chiba (JP)

(21) Appl. No.: 19/040,062

(22) Filed: Jan. 29, 2025

(30) Foreign Application Priority Data
Feb. 7, 2024 (JP) 2024-017109

(51) Int. Cl. H04N 1/00

(52) U.S. Cl. CPC H04N 1/00087; H04N 1/00015; H04N 1/00037; H04N 1/00413

(57) ABSTRACT

An image forming apparatus configured to execute a job corresponding to an application includes: a display control unit configured to display, in initial activation of the image forming apparatus, a first screen for a user to select whether to enable a save setting or not, the save setting being a setting in which, in a case where a user changes a setting value relating to the job, the changed setting value is stored in a nonvolatile storage unit; and a setting unit configured to automatically perform a setting of the job corresponding to the application based on the setting value stored in the storage unit and corresponding to the application in a case where the save setting is selected to be enabled.

### BACKGROUND

### Field of the Invention

The present disclosure relates to a setting of a job.

### Description of the Related Art

An image forming apparatus that can execute jobs corresponding to applications such as copy, scan, and facsimile is known. In the case where a user instructs execution of a job, the user sets setting values of various items such as selection of color and selection of file format (see Japanese Patent Laid-Open No. JPH05-270109).

The above-mentioned technique discloses a method of registering setting values of jobs for each of users who use the image forming apparatus and calling the registered setting values.

In the case where one person exclusively uses an image forming apparatus, an image forming apparatus that automatically saves the setting values in the previous usage and that automatically sets the saved setting values in the next usage is more useful than an image forming apparatus that registers the setting values for each user as in the above-mentioned technique. Meanwhile, in the case where such an image forming apparatus without a function of user authentication is shared and used by multiple users, there is a case where the user currently using the image forming apparatus is different from the user using the image forming apparatus next. Accordingly, the user feels inconvenient in the case where the setting values in the previous usage are automatically set.

### SUMMARY

An object of a technique of the present disclosure is to improve usability of an image forming apparatus.

An image forming apparatus of the present disclosure is an image forming apparatus configured to execute a job corresponding to an application, and includes: a display control unit configured to display, in initial activation of the image forming apparatus, a first screen for a user to select whether to enable a save setting or not, the save setting being a setting in which, in a case where a user changes a setting value relating to the job, the changed setting value is stored in a nonvolatile storage unit; and a setting unit configured to automatically perform a setting of the job corresponding to the application based on the setting value stored in the storage unit and corresponding to the application in a case where the save setting is selected to be enabled.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration of an image forming apparatus;

FIG. 2 is a block diagram illustrating a functional configuration of the image forming apparatus;

FIG. 3 is a flowchart for explaining activation processing;

FIG. 4 is a diagram illustrating an example of a save setting screen;

FIG. 5 is a diagram showing the relationship of FIG. 5A and FIG. 5B;

FIG. 5A is a flowchart for explaining setting value management;

FIG. 5B is a flowchart for explaining setting value management;

FIG. 6 is a diagram illustrating an example of a scan function selection screen;

FIG. 7 is a diagram illustrating an example of a job execution screen;

FIG. 8 is a flowchart for explaining activation processing;

FIG. 9 is a diagram illustrating an example of the save setting screen;

FIG. 10 is a diagram showing the relationship of FIG. 10A and FIG. 10B;

FIG. 10A is a flowchart for explaining setting value management; and

FIG. 10B is a flowchart for explaining setting value management.

### DESCRIPTION OF THE EMBODIMENTS

Embodiments of a technique of the present disclosure are explained below in detail in an explanatory manner by using drawings. Components described in the following embodiments are merely examples, and the scope of the technique of the present disclosure is not intended to be limited only to the components described in the following embodiments.

### Embodiment 1

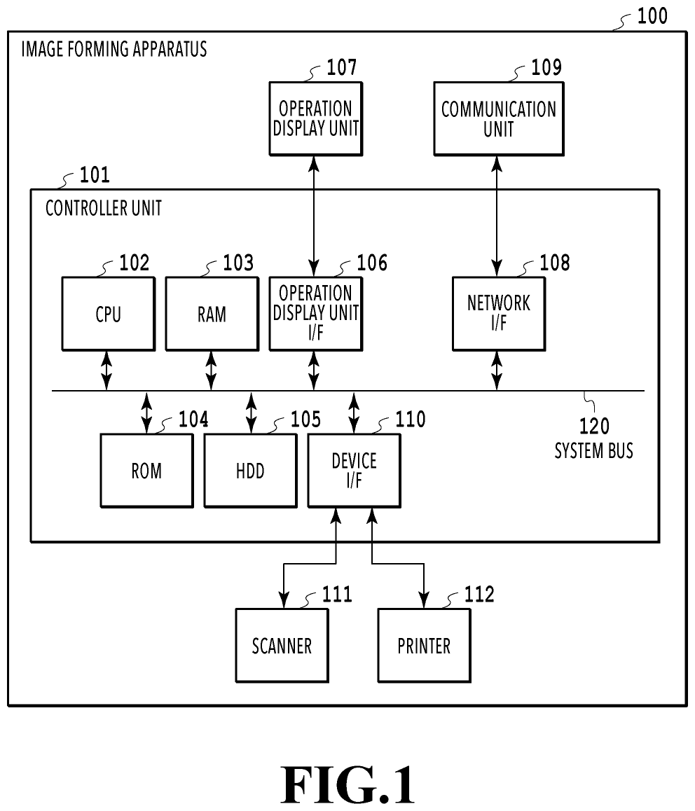

FIG. 1 is a block diagram illustrating a hardware configuration of an image forming apparatus 100 according to the present embodiment. The image forming apparatus 100 includes a controller unit 101, a scanner 111, a printer 112, an operation display unit 107, and a communication unit 109.

The controller unit 101 controls operations of the entire image forming apparatus 100. Specifically, the controller unit 101 controls the scanner 111, the printer 112, the operation display unit 107, and the communication unit 109. The controller unit 101 includes a CPU 102, a RAM 103, a ROM 104, an HDD 105, an operation display unit I/F 106, a network I/F 108, and a device I/F 110, and these units are connected to one another by a system bus 120.

The RAM 103 is a system work memory for operation of the CPU 102 and an image memory for temporarily storing image data. The RAM 103 also stores data or programs such as an operating system, system software, and application software. Moreover, the RAM 103 stores data of a scanned image obtained by causing the scanner 111 to read an original and print data received by the controller unit 101 via a network.

The ROM 104 stores a boot program of a system. The hard disk drive (HDD) 105 is a nonvolatile storage unit that stores the operating system, the system software, the application software, the print data, setting data, and the like. The CPU 102 loads the program stored in the ROM 104 onto the RAM 103 to execute the program to perform various controls for executing a job to be described later.

The CPU 102 also operates as a storage control unit that stores setting values in the nonvolatile storage unit such as the HDD 105 and reads out the setting values stored in the nonvolatile storage unit.

The operation display unit I/F 106 is an interface unit with the operation display unit 107. For example, the operation display unit 107 includes a physical button, a display unit (touch panel) with a touch panel function, and the like. For example, the physical button includes a home button for return to a home screen.

An operation performed by the user on the operation display unit 107 is converted to a signal by the operation display unit I/F 106, and the signal is received by the CPU 102. For example, a position touched by the user on the touch panel of the operation display unit 107 is detected, and a signal expressing information on this position is generated. The CPU 102 can identify the position touched by the user on the touch panel by analyzing this signal. Moreover, the operation display unit I/F 106 outputs information on a screen to be displayed on the touch panel of the operation display unit 107, to the operation display unit 107.

The network I/F 108 is connected to the communication unit 109, and performs various communication controls with a not-illustrated external apparatus. The device I/F 110 connects the printer 112 and the controller unit 101 to each other. The printer 112 has a mechanism of printing an image indicated by the image data on a print medium. Moreover, the device I/F 110 connects the scanner 111 and the controller unit 101 to each other. The scanner 111 reads an original, and generates the scanned image data expressing contents of the read original. The generated scanned image data is inputted into the controller unit 101 via the device I/F 110.

Note that the HDD 105 may be included in the external apparatus that is an apparatus different from the image forming apparatus 100. In this case, the CPU 102 stores data in the HDD 105 of the external apparatus via the communication unit 109, and obtains data from the HDD 105 of the external apparatus via the communication unit 109.

In the case where the controller unit 101 receives an instruction of executing a copy function from the user, the controller unit 101 obtains the scanned image data of the original by causing the scanner 111 to read the original, and prints the scanned image on a sheet by controlling the printer 112. In the case where the controller unit 101 receives an instruction of executing a scan transmission function from the user, the controller unit 101 obtains the scanned image data of the original by causing the scanner 111 to read the original. Then, the controller unit 101 converts the scanned image data to code data, and transmits the code data to the external apparatus (not illustrated) via the communication unit 109. A series of processes based on an execution instruction of each of functions such as the copy function and the scan transmission function is referred to as job. The image forming apparatus 100 executes predetermined processes according to the job corresponding to each function. The image forming apparatus 100 also functions as a job processing apparatus that executes the job corresponding to each function. The function corresponding to the job executed by the image forming apparatus 100 is not limited to the copy function and the scan transmission function.

### Functional Configuration

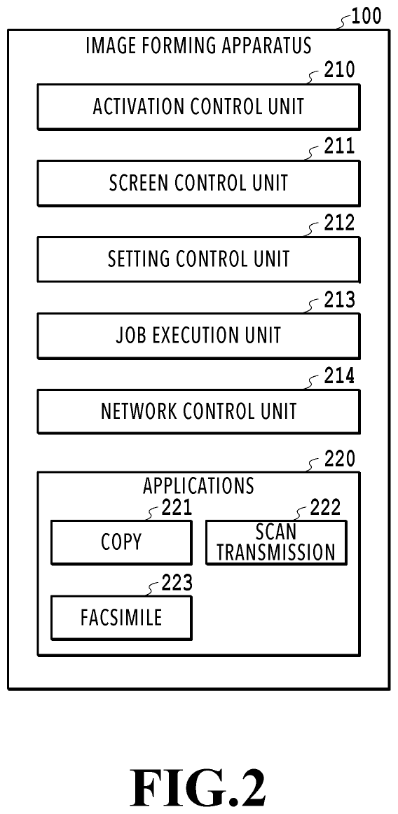

FIG. 2 is a block diagram illustrating a functional configuration of the image forming apparatus 100 according to the present embodiment.

The image forming apparatus 100 includes multiple applications 220 for implementing the respective functions. The multiple applications 220 include a copying application 221 that executes the job of the copy function described above, a scan transmission application 222 that executes the job of the scan transmission function, a facsimile application 223, and the like. An application selected by the user among the multiple applications 220 is executed. The scan transmission application 222 is an application that executes the job of transmitting the scanned image data, obtained by causing the scanner 111 to scan the original, to the external apparatus. The applications 220 illustrated FIG. 2 are examples of applications that execute jobs relating to image processing, and may include other applications.

An activation control unit 210 controls processing in activation of the image forming apparatus 100.

An screen control unit 211 performs display control of displaying a screen provided by a currently-executed application, on the touch panel of the operation display unit 107. Moreover, the screen control unit 211 identifies the position touched by the user on the touch panel of the operation display unit 107, based on a signal from the operation display unit 107. Then, the screen control unit 211 instructs the running application to perform processing associated with an operation button or the like corresponding to the position touched by the user.

In the case where a “save setting” to be described later is enabled, a setting control unit 212 stores setting values that relate to a job and that are changed by the user for execution of the job by an application, in the HDD 105. Moreover, in the case where the application is executed in the situation where the “save setting” is enabled, the setting control unit 212 automatically performs a setting of the job corresponding to this application by storing the setting values stored in the HDD 105, in the RAM 103.

Hereinafter, the setting values are assumed to refer to values of an item group set for execution of the job unless otherwise noted. The “item group” is assumed to indicate a group of items set for execution of the job by the currently-executed application. For example, in the case where the currently-executed application is the scan transmission application 222, the item group is assumed to indicate a group of items of “size of original”, “resolution”, “color setting”, and “double-sided/single-sided printing”. For example, the setting value of the item of “size of original” is “A4”, “A3”, “B4”, or the like.

A job execution unit 213 obtains the setting values stored in the RAM 103 in the case where pressing of an execution button of the job is identified, and causes the currently-executed application to execute the job based on the obtained setting values. For example, in the case where the currently-executed application is the scan transmission application 222, upon instruction of the execution of the job, the job execution unit 213 causes the scanner 111 to read the original placed on a platen glass and generate the scanned image data, via the device I/F 110.

A network control unit 214 controls the communication unit 109 via the network I/F 108, and transmits the image data to the external apparatus.

Note that the configuration may be such that at least one of the functional units 211 to 214 in FIG. 2 is included in the applications. In the present embodiment, explanation is given assuming that the functions of the screen control unit 211, the setting control unit 212, and the job execution unit 213 are included also in the applications.

Although the CPU 102 implements the functions of the respective blocks in FIG. 2 by loading a predetermined program stored in the ROM 104 or the HDD 105 onto the RAM 103 and executing the program, the present disclosure is not limited to this. Alternatively, for example, hardware such as a graphics processing unit (GPU) or a field programmable gate array (FPGA) for increasing the speed of computation may be used. Each function may be implemented by cooperation of software and hardware such as a dedicated IC, or some or all of the functions may be implemented only by hardware.

### [Regarding Save Setting]

In the image forming apparatus 100 of the present embodiment, there is a setting for saving the job setting in execution of the job by the application (hereinafter, also simply referred to as save setting), and the “save setting” is set to either enabled or disabled.

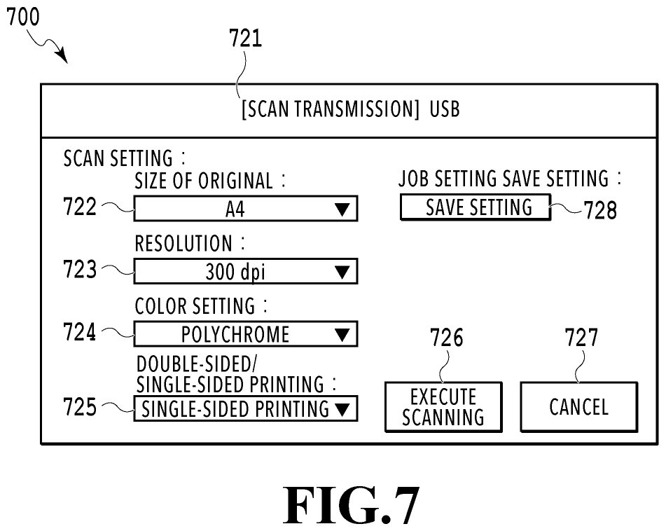

In the case where the “save setting” is set to enabled, the setting values changed by the user for the execution of the job through a job execution screen 700 (see FIG. 7) to be described later are maintained as they are with the contents remaining the same, unless the user gives an explicit instruction to change the setting values. For example, control is performed such that the setting values changed by the user are stored in the RAM 103 for the execution of the current job, and are further stored in the HDD 105 to be used in the next execution of the application.

In the case where the “save setting” is set to disabled, the setting values changed by the user for the execution of the job through the job execution screen 700 (see FIG. 7) to be described later are not stored in the HDD 105. Accordingly, in the case where the application is executed in the state where the “save setting” is set to disabled, initial values are set as the setting values.

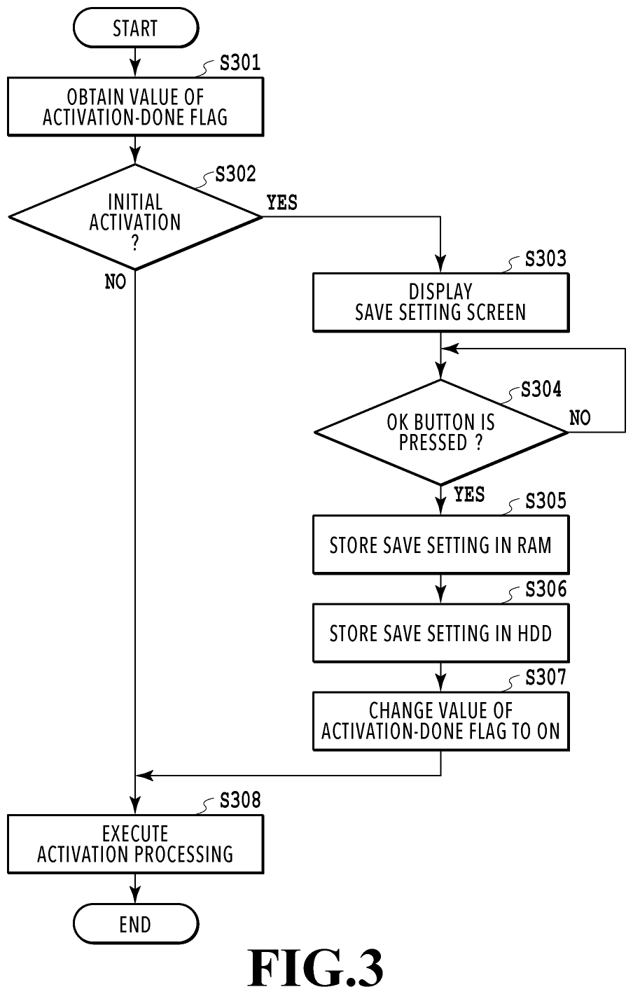

FIG. 3 is a flowchart for explaining activation processing of the image forming apparatus 100 in the present embodiment. The CPU 102 performs a series of processes illustrated in the flowchart of FIG. 3 by loading a program code, that is used to implement the activation processing and that is stored in the ROM 104 or the HDD 105, onto the RAM 103 and executing the program code. Moreover, functions of some or all of the steps in FIG. 3 may be implemented by hardware such as an ASIC or an electronic circuit. Note that the sign “S” in explanation of each step in the flowchart, and the same applies also to the following flowcharts.

The present flowchart starts in the case where the power of the image forming apparatus 100 is switched from OFF to ON.

In S301, the activation control unit 210 obtains a value of an “activation-done flag”.

The value of the activation-done flag is, for example, one of ON and OFF, and is stored in the HDD 105. For example, in shipping of the image forming apparatus 100, OFF is stored in the HDD 105 as the value of the activation-done flag. In the case where the save setting to be described later is performed in initial activation of the image forming apparatus 100, the value of the activation-done flag is changed to ON, and is stored in the HDD 105 as ON from hereon. The activation control unit 210 obtains the value of the activation-done flag, and can determine that the current activation is the initial activation in the case where the value indicates OFF. Accordingly, at least the first activation after the shipping is determined to be the initial activation. Note that, in the case where an initializing operation of restoring the image forming apparatus 100 to a state at product shipping is performed, the value of the activation-done flag is changed to OFF. Accordingly, the first activation after the initialization operation is also included in the initial activation.

In S302, the activation control unit 210 determines whether the current activation of the image forming apparatus 100 is the initial activation or not based on the obtained value of the activation-done flag. In the case where the activation control unit 210 determines that the current activation is the initial activation (YES in S302), the activation control unit 210 causes the processing to proceed to S303.

In S303, the activation control unit 210 displays a save setting screen that makes the user select “save setting” enabled or “save setting” disabled, on the touch panel of the operation display unit 107 via the screen control unit 211.

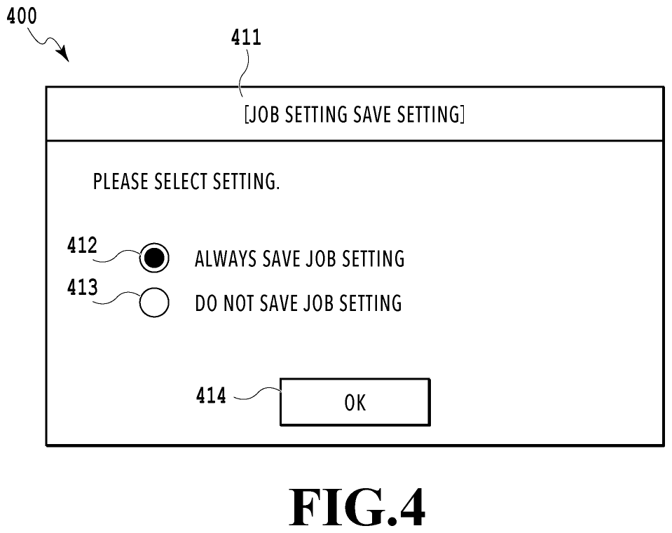

FIG. 4 is a diagram illustrating an example of the save setting screen. A title region 411 included in the save setting screen 400 of FIG. 4 is a region in which a name of the screen is displayed to notify the user that a displayed pop-up is the save setting screen.

The save setting screen 400 includes radio buttons 412 and 413. The radio button 412 is a radio button for selecting the “save setting” enabled described above. The radio button 413 is a radio button for selecting the “save setting” disabled described above. An OK button 414 is controlled to receive pressing in the case where one of the radio button 412 and the radio button 413 is selected.

Returning to the explanation of the flowchart of FIG. 3, in S304, the activation control unit 210 determines whether one of the radio button 412 and the radio button 413 in the save setting screen 400 is selected and the OK button 414 is pressed or not via the screen control unit 211. In the case where the OK button 414 is not pressed (NO in S304), the activation control unit 210 repeats S304 until the OK button 414 is pressed, and waits for the pressing of the OK button 414.

In the case where the activation control unit 210 determines that the OK button 414 is pressed (YES in S304), the activation control unit 210 causes the processing proceed to S305.

In S305, the activation control unit 210 stores the value of the “save setting” indicating the contents selected by the user in the save setting screen 400, in the RAM 103. The value of the “save setting” is one of the value indicating enabled and the value indicating disabled. In the case where the radio button 412 is selected and the OK button 414 is pressed, the value indicating the “save setting” enabled is stored in the RAM 103. In the case where the radio button 413 is selected and the OK button 414 is pressed, the value indicating the “save setting” disabled is stored in the RAM 103.

In S306, the activation control unit 210 stores the value of the “save setting” indicating the contents selected by the user in the save setting screen 400, in the HDD 105. In the case where the value indicating the “save setting” enabled is stored in the RAM 103 in S305, the value indicating the “save setting” enabled is stored in the HDD 105. In the case where the value indicating the “save setting” disabled is stored in the RAM 103 in S305, the value indicating the “save setting” disabled is stored in the HDD 105.

As described above, in the case where the OK button 414 is pressed, whether the “save setting” is enabled or disabled is fixed. In the present embodiment, explanation is given assuming that the “save setting” performed through the save setting screen 400 of FIG. 4 is applied to all applications included in the multiple applications 220 of the image forming apparatus 100 as an example. Alternatively, the “save setting” performed through the save setting screen 400 of FIG. 4 may be applied only to some of the applications such as, for example, only to the scan transmission application. In this case, the save setting of the other applications may be set to enabled or disabled in advance.

In S307, the activation control unit 210 changes the value of the activation-done flag stored in the HDD 105 to the value of ON. Specifically, the ON value is reflected in the value of the activation-done flag stored in the HDD 105 such that the next activation is determined as the second or subsequent activation. The activation control unit 210 causes the processing to proceed to S308.

Moreover, in the case where the activation control unit 210 determines that the current activation is the second or subsequent activation in S302 (NO in S302), the activation control unit 210 causes the processing to proceed to S308.

In S308, the activation control unit 210 executes the activation processing of the image forming apparatus 100. Then, the present flowchart is terminated.

### [Regarding Management Processing of Setting Values of Job]

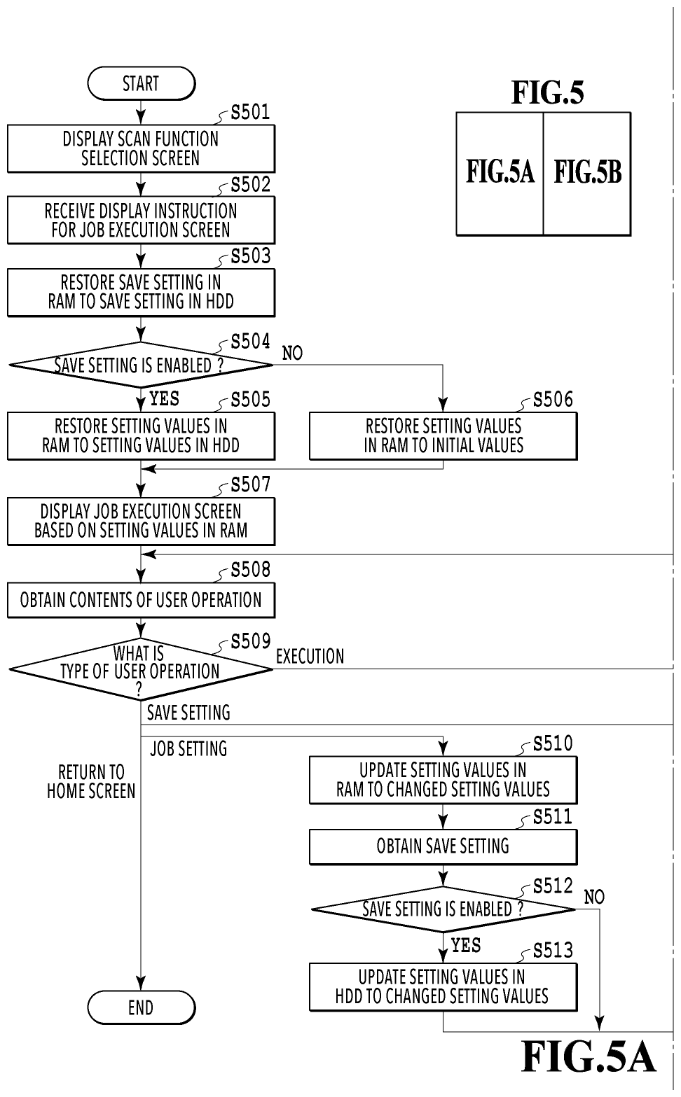

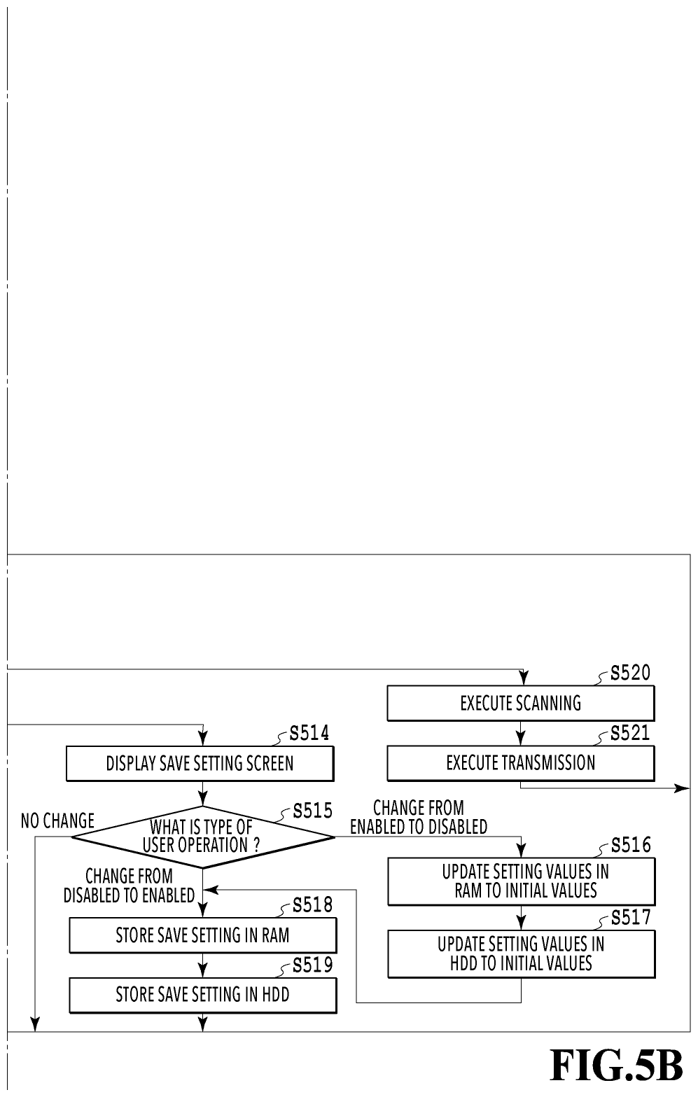

FIGS. 5A and 5B are flowcharts for explaining setting value management of the job executed by the application of the image forming apparatus 100 in the present embodiment. The CPU 102 performs a series of processes illustrated in the flowcharts of FIGS. 5A and 5B by loading a program code that is used to implement the functional units and that is stored in the ROM 104 or the HDD 105, onto the RAM 103 and executing the program code. Moreover, functions of some or all of the steps in FIGS. 5A and 5B may be implemented by hardware such as an ASIC or an electronic circuit.

FIGS. 5A and 5B illustrate a flow of the job setting value management in the case where the scan transmission application 222 among the multiple applications is executed. The scan transmission application 222 is an example of the currently-executed application. Moreover, processing similar to the flowcharts of FIGS. 5A and 5B is executed also in the case where the other applications such as copy, facsimile, and the like are executed. The flowchart of FIG. 5A is started, for example, in the case where the user designates the scan transmission application 222 in the not-illustrated home screen.

Note that the image forming apparatus 100 of the present embodiment is assumed to be an apparatus that does not perform user authentication. Accordingly, it is assumed that the user can operate the image forming apparatus 100 without logging in.

In S501, the scan transmission application 222 displays a scan function selection screen on the touch panel of the operation display unit 107.

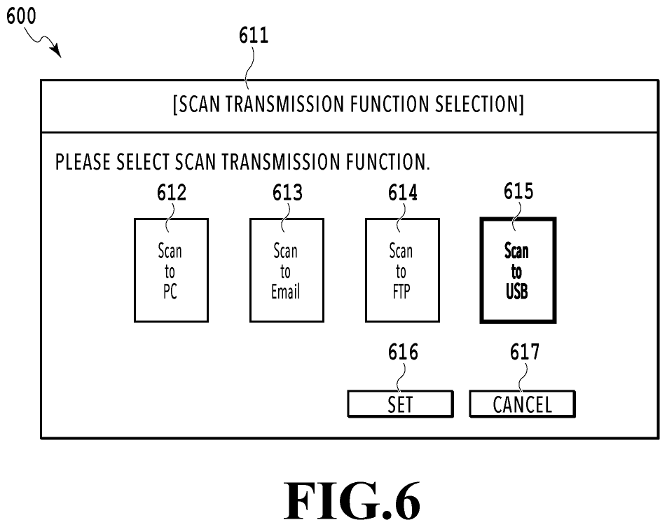

FIG. 6 is a diagram illustrating an example of the scan function selection screen. The scan function selection screen 600 of FIG. 6 includes a title region 611, buttons 612 to 615, a setting button 616, and a cancel button 617. The title region 611 is a region in which a title of the application is displayed.

The buttons 612 to 615 are buttons for selection of a transmission protocol of the scanned image by the user, the scanned image obtained by causing the scanner to scan the original. The button 612 is a button for selecting a scan transmission protocol “scan to PC” in which the data of the scanned image is transmitted to a PC (not illustrated). The button 613 is a button for selecting a scan transmission protocol “scan to E-mail” in which the data of the scanned image is attached to an E-mail and transmitted. The button 614 is a button for selecting a scan transmission protocol “scan to FTP” in which the data of the scanned image is transmitted to an FTP server (not illustrated). The button 615 is a button for selecting a scan transmission protocol “scan to USB” in which the data of the scanned image is transmitted to a USB memory (not illustrated) connected to the image forming apparatus 100.

The user can select only one of the buttons 612 to 615, and the selected button is displayed such that the user can identify the selection of the button. FIG. 6 illustrates that the button 615 of the scan transmission protocol “scan to USB” is the button selected by the user, and the boundary of the selected button 615 and the characters inside the selected button 615 are displayed while being highlighted as an example.

The setting button 616 is a button whose pressing by the user is enabled only in the case where one of the buttons 612 to 615 is selected. In the case where the setting button 616 is pressed, the job execution screen 700 (see FIG. 7) of the scan transmission protocol indicated by the selected button among the buttons 612 to 615 is displayed. In the case where the cancel button 617 is pressed, although omitted in the flowcharts of FIGS. 5A and 5B, the scan transmission application 222 terminates the processing, and returns to the home screen.

In S502, in the case where the setting button 616 is pressed, the scan transmission application 222 obtains a display instruction for the job execution screen of the scan transmission protocol selected in the scan function selection screen 600, via the screen control unit 211. In the example of FIG. 6, the button 615 of the scan transmission protocol “scan to USB” is selected. Accordingly, in the case where the setting button 616 is pressed in the state of FIG. 6, the display instruction for the job execution screen of the scan transmission protocol “scan to USB” is obtained.

In S503, the scan transmission application 222 obtains the value of the “save setting” stored in the HDD 105. As described above, one of the value indicating enabled or the value indicating disabled is stored in the HDD 105 as the value of the “save setting”. Then, the scan transmission application 222 loads the obtained value of the “save setting” onto the RAM 103, and restores the value of the “save setting”.

In S504, the scan transmission application 222 determines whether the “save setting” is enabled or not based on the value of the “save setting” obtained in S503. In the case where the scan transmission application 222 determines that the “save setting” is enabled (YES in S504), the scan transmission application 222 causes the processing to proceed to S505.

In S505, the scan transmission application 222 stores the setting values of the scan transmission application 222 stored in the HDD 105, in the RAM 103 to perform the setting of the job.

As described in detail later, assume that the user changes the setting values through the job execution screen 700 (see FIG. 7) of the scan transmission application in the state where the “save setting” is enabled. In this case, the changed setting values are stored in the HDD 105 as the setting values of the scan transmission application. In the case where the setting values of the scan transmission application are already stored in the HDD 105, the setting values of the scan transmission application stored in the HDD 105 are updated to the changed setting values by the user. As described above, in the present embodiment, in the case where the “save setting” is enabled, the setting values set by the user are stored in the HDD 105 in association with each application. Accordingly, the scan transmission application 222 can restore the setting values in the RAM 103 to the setting values set in the previous execution of the application by the user. Thus, in the case where the next time the home screen is selected and the scan transmission application 222 transitions to S505 in the state where the “save setting” is enabled, the setting values of the scan transmission application stored in the HDD 105 are stored in the RAM 103. In the case where there is no change in the setting values in the state where the “save setting” is enabled, in S505, the initial values stored in the HDD 105 are stored in the RAM 103.

Note that the job execution screen 700 (see FIG. 7) of the present embodiment is assumed to be provided with no button for resetting the setting values to the initial values. The operation display unit 107 is also assumed to be provided with no operation units for resetting the setting values to the initial values. Accordingly, in the case where the setting values are changed in the state where the “save setting” is enabled, these setting values are maintained as they are until the next changing of the setting values.

In the case where the scan transmission application 222 determines that the “save setting” is disabled (NO in S504), the scan transmission application 222 causes the processing to proceed to S506. In S506, the scan transmission application 222 stores values (initial values) indicating an initial state of the scan transmission application in the RAM 103 as the setting values of the scan transmission application 222. For example, the initial values for each application are stored in the HDD 105. Accordingly, the scan transmission application 222 can restore the setting values in the RAM 103 to the initial values of the scan transmission application.

In S507, the scan transmission application 222 displays the job execution screen reflecting the setting values stored in the RAM 103, on the touch panel of the operation display unit 107.

FIG. 7 is a diagram illustrating an example of the job execution screen of the scan transmission application. The job execution screen 700 of FIG. 7 includes a title region 721, pull-down menus 722 to 725, a scan execution button 726, a cancel button 727, and a save setting button 728. The title region 721 is a region in which a name of the currently-executed application is displayed.

The pull-down menus 722 to 725 are provided for the respective items of the job described above, and the currently-set setting values, that is the setting values stored in the RAM 103 are displayed in the pull-down menus 722 to 725. In the case where the pull-down menus 722 to 725 are pressed, lists for specification of the setting values by the user are displayed.

In the case where the “save setting” is disabled, as a result of the process of S506, the initial values are stored in the RAM 103 as the setting values. Accordingly, in transition from S506 to S507, there is displayed the job execution screen 700 in which the initial values are displayed as the setting values in the pull-down menus 722 to 725 of the respective items.

In the case where the “save setting” is enabled, as a result of the process of S505, the setting values in the previous execution of the scan transmission application are stored in the RAM 103 as the setting values. Accordingly, in the transition from S505 to S507, there is displayed the job execution screen in which the setting values used in the previous job corresponding to the scan transmission application are displayed in the pull-down menus 722 to 725 of the respective items.

In case where the pull-down menu 722 is pressed, a list of setting values of sizes in reading of the original by the scanner 111 is displayed in the pull-down menu 722. A size selected by the user from the list is set as the setting value of the changed size. In the case where the pull-down menu 723 is pressed, a list of resolutions of the scanned image is displayed in the pull-down menu 723, and a resolution selected by the user from the list is set as the setting value of the changed resolution. In the case where the pull-down menu 724 is pressed, a list including at least polychrome and monochrome is displayed in the pull-down menu 724, and a setting value selected by the user from the list is set as the setting value of the changed color setting. In the case where the pull-down menu 725 is pressed, a list including single-sided printing and double-sided printing is displayed in the pull-down menu 725, and a setting value selected by the user from the list is set as the setting value of double-sided/single-sided printing in the scanning of the original.

The scan execution button 726 is a button for executing the job. In the case where the scan execution button 726 is pressed, the job is executed according to the setting values stored in the RAM 103 that are the setting values displayed in the pull-down menus 722 to 725.

In the case where the cancel button 727 is pressed, although omitted in the flowcharts of FIGS. 5A and 5B, the scan transmission application 222 terminates the processing, and processing of returning to the home screen is performed. The save setting button 728 is a button for displaying the save setting screen 400 of FIG. 4.

In S508, the scan transmission application 222 waits for an operation of the user on the operation display unit 107. In the case where the user performs an operation on the operation display unit 107, the scan transmission application 222 obtains contents of this operation. In the case where the user presses any of the operation buttons on the job execution screen 700 displayed on the touch panel of the operation display unit 107, the scan transmission application 222 obtains information on the pressed operation button via the screen control unit 211. Moreover, in the case where the not-illustrated home button that is used to return to the home screen and that is included in the operation display unit 107 is pressed, the scan transmission application 222 obtains pressing of the home button.

In S509, the scan transmission application 222 switches the processing depending on the operation of the user on the operation display unit 107.

In the case where the scan transmission application 222 determines that the type of the obtained user operation is “job setting” in S509, the scan transmission application 222 executes processes of S510 to S513. The “job setting” is an operation in which the user presses one of the pull-down menus 722 to 725 on the job execution screen 700 of FIG. 7 and changes the setting value relating to the job of the scan transmission application such as the size of original, the resolution, the color setting, or the like.

In S510, the scan transmission application 222 obtains the setting value changed by the operation obtained in S508. Then, the scan transmission application 222 updates the setting value stored in the RAM 103 such that the setting value is set to the setting value changed by the user. For example, in the case where the setting value of the “size of original” is changed from “A4” to “B4” in the job execution screen 700, “B4” is obtained as the changed setting value of the “size of original”. Then, the setting value of the “size of original” of the scan transmission application stored in the RAM 103 is updated to “B4” that is the changed setting value. Then, the scan transmission application 222 causes the processing to return to S508.

In S511, the scan transmission application 222 obtains the value of the “save setting” currently stored in the RAM 103.

In S512, the scan transmission application 222 determines whether the “save setting” is enabled or not based on the value of the “save setting” obtained in S511.

In the case where the scan transmission application 222 determines that the “save setting” is enabled (YES in S512), the scan transmission application 222 causes the processing to proceed to S513. In S513, the scan transmission application 222 stores the setting value changed by the operation obtained in S508 in the HDD 105.

Meanwhile, in the case where the scan transmission application 222 determines that the “save setting” is disabled (YES in S512), the scan transmission application 222 skips S513, and causes the processing to return to S508.

As described above, in the case where the “save setting” is enabled, the setting values set by the user to execute the current job are stored in the HDD 105. In the case where the setting values are already stored in the HDD 105, the setting values are updated to the setting values changed by the user to execute the current job. Meanwhile, in the case where the “save setting” is disabled, control is performed such that the setting values changed by the operation of the user are not stored in the HDD 105.

For example, assume that the setting values are changed to the setting values illustrated in the job execution screen 700 of FIG. 7 in the state where the “save setting” is enabled, the job is executed, and the scan transmission application is terminated. In this case, the image forming apparatus 100 is in a state where the setting values of “size of original”, “resolution”, “color setting”, and “double-sided/single-sided printing” illustrated in the job execution screen 700 of FIG. 7 are stored in the HDD 105. Specifically, “A4” is stored as the setting value of “size of original”, “300 dpi” is stored as the setting value of “resolution”, “polychrome” is stored as the setting value of “color setting”, and “single-sided printing” is stored as the setting value of “double-sided/single-sided printing” in the HDD 105. Accordingly, in the case where the scan transmission application is executed next time in the state where the “save setting” is enabled, the setting values are automatically set to the state of the job execution screen 700 in FIG. 7.

Next, in the case where the scan transmission application 222 determines that the type of the obtained user operation is the save setting in S509, the scan transmission application 222 executes processes of S514 to S519. The type of the user operation being the “save setting” is an operation in which the user presses the save setting button 728 of the job execution screen 700.

In S514, the scan transmission application 222 displays the save setting screen 400 of FIG. 4 as a pop-up on the touch panel of the operation display unit 107 via the screen control unit 211. In the case where the value of the “save setting” stored in the RAM 103 is the value indicating enabled, the scan transmission application 222 displays the save setting screen 400 in the state where the radio button 412 for selecting enabled is selected. In the case where the value of the “save setting” stored in the RAM 103 is the value indicating disabled, the scan transmission application 222 displays the save setting screen 400 in the state where the radio button 413 for selecting disabled is selected.

In S515, the scan transmission application 222 switches the processing depending on an operation of the user on the save setting screen 400 displayed in S514. In the case where the radio button 413 is selected in the state where the radio button 412 is selected and the OK button 414 is pressed, the scan transmission application 222 determines that an operation of changing the “save setting” from enabled to disabled is performed in S515. In this case, the scan transmission application 222 causes the processing to proceed to S516.

In S516, the scan transmission application 222 updates the setting values of the scan transmission application 222 stored in the RAM 103 to the initial values.

In S517, the scan transmission application 222 updates the setting values of the scan transmission application 222 stored in the HDD 105 to the initial values.

In S518, the scan transmission application 222 updates the value of the “save setting” stored in the RAM 103 to the value indicating the contents changed by the user through the save setting screen 400. Specifically, in the case where the radio button 412 is selected and the OK button 414 is pressed, the value of the “save setting” stored in the RAM 103 is updated to the value indicating enabled. In the case where the radio button 413 is selected and the OK button 414 is pressed, the value of the “save setting” stored in the RAM 103 is updated to the value indicating disabled.

In S519, the scan transmission application 222 updates the value of the “save setting” stored in the HDD 105 to the value indicating the contents selected by the user in the save setting screen 400. Specifically, in the case where the radio button 412 is selected and the OK button 414 is pressed, the value of the “save setting” stored in the HDD 105 is updated to the value indicating enabled. In the case where the radio button 413 is selected and the OK button 414 is pressed, the value of the “save setting” stored in the HDD 105 is updated to the value indicating disabled. In the case where S519 is completed, the processing returns to S508.

Meanwhile, in the case where the radio button 412 is selected in the state where the radio button 413 is selected and the OK button is pressed, the scan transmission application 222 determines that an operation of changing the save setting from disabled to enabled is performed in S515. In this case, S516 and S517 are skipped, and the processes of S518 and S519 are executed.

Moreover, in the case where the selection of the radio button 413 or 412 is not changed and the OK button 414 is pressed, the scan transmission application 222 determines that the operation of changing the “save setting” is not performed in S515. In this case, S516 to S519 are skipped, and the processing returns to S508.

Next, in the case where the scan transmission application 222 determines that the type of the user operation is “job execution” in S509, the scan transmission application 222 executes processes of S520 to S521. The type of the user operation being “job execution” is an operation of executing the job, and is an operation corresponding to pressing of the scan execution button 726.

In S520, the scan transmission application 222 causes the scanner 111 to execute scanning of the original according to the setting values stored in the RAM 103, and thereby generates the scanned image data of the original. During the execution of the job, the scan transmission application 222 displays a dialog (not illustrated) notifying the user that the scanning is being executed, in front of the job execution screen 700.

In S521, the scan transmission application 222 transmits the scanned image data to a device corresponding to the transmission protocol stored in the RAM 103. In the case where the scan transmission protocol “scan to USB” is selected, the scanned image is transmitted to the USB memory. The scan transmission application 222 displays a dialog (not illustrated) notifying the user that transmission processing is being executed, in front of the job execution screen 700 until the transmission of the scanned image data is completed.

Moreover, in the case where the scan transmission application 222 determines that the type of the obtained user operation is “return to the home screen” in S509, the scan transmission application 222 terminates the present flowchart. The type of the user operation being “return to the home screen” is an operation in which the not-illustrated home button in the operation display unit 107 is pressed. In the case where the operation display unit 107 returns to the home screen and the scan transmission application 222 is selected, the flowcharts of FIGS. 5A and 5B are started again.

For example, in the case where the image forming apparatus is in an environment where it is used by one user, in some cases, it is more preferable that the setting values of the job are automatically set to the setting values used in the previous job. Meanwhile, in the case where the image forming apparatus is in an environment where it is used by multiple users, in some cases, it is more preferable that the setting values of the job are set to the initial values. According to the present embodiment, in the initial activation of the image forming apparatus, the user can select either the operation of setting the setting values to the initial values or the operation of storing the setting values to automatically set the setting values of the current job to the previous setting values. Accordingly, the usability of the image forming apparatus can be improved in the present embodiment.

### Embodiment 2

In Embodiment 1, explanation is given assuming that the save setting made through the save setting screen 400 of FIG. 4 is applied to all applications in the image forming apparatus 100. However, in some cases, it is more preferable that the user can set the save setting such that the values of the “save setting” of the respective applications vary from one another such as the case where the “save setting” of the scan transmission application is enabled while the “save setting” of the copy application is disabled. Accordingly, in the present embodiment, explanation is given of a method in which the values of the “save setting” of the respective applications can be set to be varied from one another. In the present embodiment, differences from Embodiment 1 are mainly explained. Parts not explicitly described are the same configurations and processes as those in Embodiment 1.

### [Regarding Save Setting]

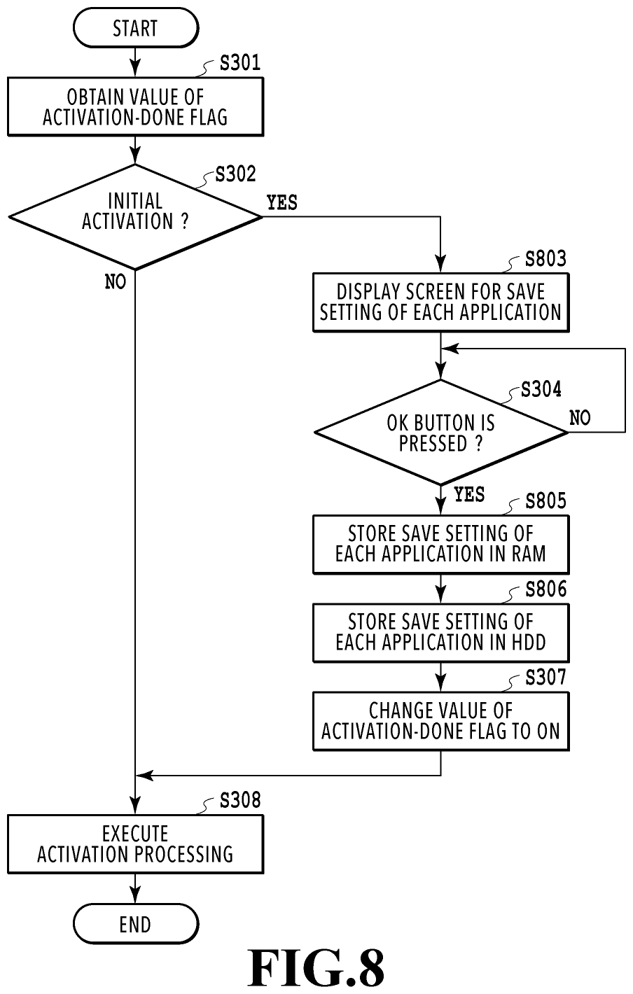

FIG. 8 is a flowchart for explaining activation processing of the image forming apparatus 100 in the present embodiment. The steps in the flowchart of FIG. 8 that are the same as the steps in the flowchart of FIG. 3 are denoted by the same reference numerals also in FIG. 8. Accordingly, in the explanation of the flowchart of FIG. 8, steps different from those in the flowchart of FIG. 3 are explained. In the flowchart of FIG. 8, S803 is executed instead of S303 in FIG. 3. Moreover, S805 to S806 are executed instead of S305 to S306.

In S803, the activation control unit 210 displays a save setting screen that makes the user select “save setting” enabled or “save setting” disabled for each application, as a pop-up on the touch panel of the operation display unit 107 via the screen control unit 211.

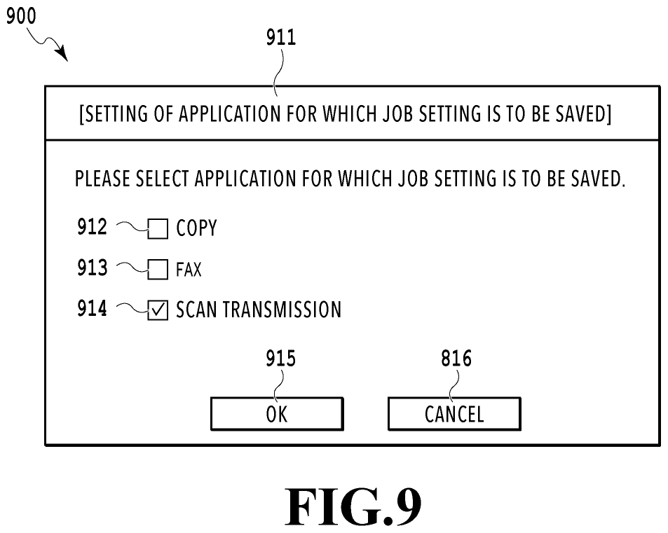

FIG. 9 is a diagram illustrating an example of a save setting screen in the present embodiment that is displayed in S803. The save setting screen 900 of FIG. 9 includes check boxes 912 to 914 corresponding, respectively, to the multiple applications 220 included in the image forming apparatus 100. Assuming that the applications included in the image forming apparatus 100 are the copy application, the facsimile application, and the scan transmission application as illustrated in FIG. 2, the check boxes 912 to 914 are provided to correspond to these respective three applications.

In the case where at least one of the check boxes 912 to 914 is checked and an OK button 915 is pressed, the “save setting” is set to be enabled only for the application corresponding to the checked check box. Specifically, the “save setting” of the application corresponding to the unchecked check box is set to be disabled.

For example, in FIG. 9, only the check box 914 corresponding to the scan transmission application is checked. Accordingly, in the case where the OK button 915 is pressed in the state of FIG. 9, the “save setting” of the scan transmission application is set to enabled. Since the check boxes 912 and 913 corresponding to the copy application and the facsimile application are unchecked, the “save setting” of the copy application and the facsimile application are set to disabled. In the case where a cancel button 916 is pressed, the setting is cancelled.

In S805, the activation control unit 210 stores the value of the “save setting” of each application in the RAM 103. In S806, the activation control unit 210 stores the value of the “save setting” of each application in the HDD 105.

### [Regarding Management Processing of Setting Values of Job]

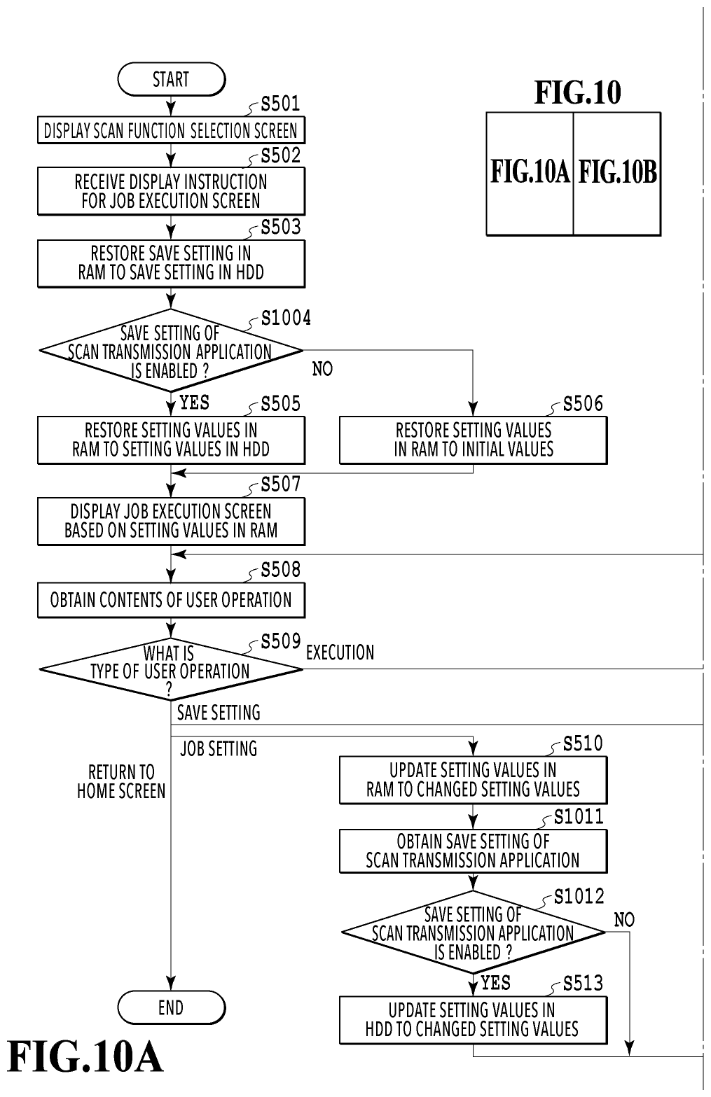

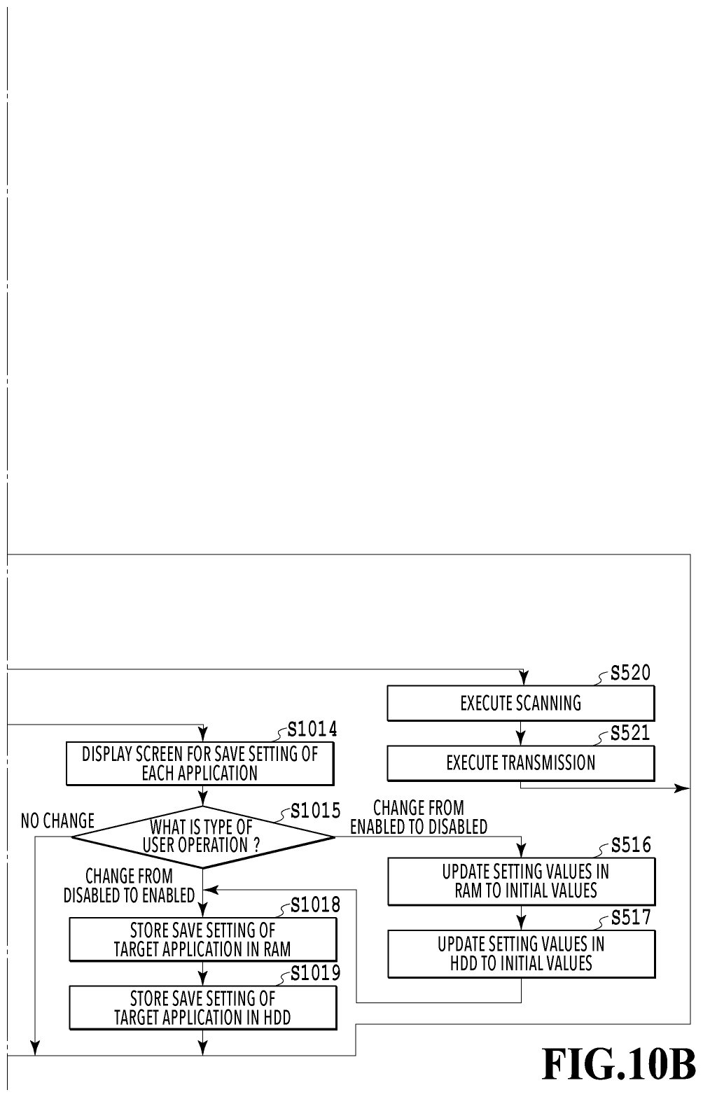

FIGS. 10A and 10B are flowcharts for explaining processing of job setting value management executed by the image forming apparatus 100 in the present embodiment. The CPU 102 performs a series of processes illustrated in the flowcharts of FIGS. 10A and 10B by loading a program code stored in the ROM 104 or the HDD 105 onto the RAM 103 and executing the program code. Moreover, functions of some or all of the steps in FIGS. 10A and 10B may be implemented by hardware such as an ASIC or an electronic circuit.

The flowcharts of FIGS. 10A and 10B illustrate a flow of the job setting value management in the case where the scan transmission application 222 among the multiple applications is selected as in the flowcharts of FIGS. 5A and 5B. The steps in the flowcharts of FIGS. 10A and 10B that are the same as the steps in the flowcharts of FIGS. 5A and 5B are denoted by the same reference numerals also in FIGS. 10A and 10B. Accordingly, in the explanation of the flowcharts of FIGS. 10A and 10B, steps different from those in the flowcharts of FIGS. 5A and 5B are explained.

In the flowcharts of FIGS. 10A and 10B, processes of S1003 to S1004 are performed instead of the processes of S503 to S504 in FIGS. 5A and 5B.

In S1003, the scan transmission application 222 loads the value of the “save setting” of the currently-executed application among the values of the “save setting” of the respective applications saved in the HDD 105, onto the RAM 103. In the flowcharts of FIGS. 10A and 10B, the currently-executed application is the scan transmission application. Accordingly, in S1003, the value of the “save setting” of the scan transmission application is obtained from among the values of the “save setting” of the respective applications saved in the HDD 105, and the obtained value is stored in the RAM 103.

In S1004, the scan transmission application 222 determines whether the “save setting” of the scan transmission application that is the currently-executed application is enabled or not, based on the value of the “save setting” stored in the RAM 103 in S1003. In the case where the scan transmission application 222 determines that the “save setting” of the scan transmission application is enabled (YES in S1004), the processing proceeds to S505. In S505, the scan transmission application 222 stores the setting values of the scan transmission application 222 among the setting values of the respective applications stored in the HDD 105, in the RAM 103.

Meanwhile, in the case where the scan transmission application 222 determines that the “save setting” of the scan transmission application is disabled in S1004 (NO in S1004), the scan transmission application 222 causes the processing to proceed to S506. In S506, the scan transmission application 222 stores the initial values of the scan transmission application, in the RAM 103 as the setting values of the scan transmission application that is the currently-executed application.

Next, in the case where the scan transmission application 222 determines that the type of the obtained user operation is “job setting” in S509 of FIGS. 10A and 10B, processes of S510, S1011, S1012, and S513 are executed in FIGS. 10A and 10B instead of the processes of S510, S511, S512, and S513 in FIGS. 5A and 5B.

In S510, the scan transmission application 222 stores the setting values changed by the user this time, in the RAM 103. Then, the processing proceeds to S1011.

In S1011, the scan transmission application 222 obtains the value of the “save setting” of the scan transmission application from the RAM 103. Then, the processing proceeds to S1012.

In S1012, the scan transmission application 222 determines whether the “save setting” of the scan transmission application is enabled or not based on the value of the “save setting” of the scan transmission application obtained in S1011.

In the case where the scan transmission application 222 determines that the “save setting” of the scan transmission application is enabled (YES in S1012), the scan transmission application 222 causes the processing to proceed to S513. In S513, the scan transmission application 222 stores the currently-changed setting values in the HDD 105. Meanwhile, in the case where the scan transmission application 222 determines that the “save setting” of the scan transmission application is disabled (NO in S1012), S513 is skipped, and the processing returns to S508.

Next, in the case where the scan transmission application 222 determines that the type of the obtained user operation is “save setting” in S509 of FIGS. 10A and 10B, processes of S1014, S1015, S516, S517, S1018, and S1019 are executed in FIGS. 10A and 10B instead of the processes of S514 to S519 in FIGS. 5A and 5B.

In S1014, the scan transmission application 222 displays the save setting screen 900 of the present embodiment in FIG. 9 as a pop-up on the touch panel of the operation display unit 107 via the screen control unit 211. Then, the processing proceeds to S1015.

As explained above, the save setting screen 900 is a save setting screen in which whether to enable or disable the “save setting” can be set for each application. However, the save setting screen 900 displayed in S1014 is assumed to be displayed such that changing of save setting for the applications other than the currently-executed application is not received. Specifically, since the currently-executed application is the scan transmission application in the case of the flowcharts of FIGS. 10A and 10B, the save setting screen 900 is displayed such that changing between the checked state and the unchecked state is possible only for the check box 914 of the scan transmission application. In order to indicate that the check boxes 912 and 913 are unchangeable, these check boxes are displayed while being, for example, grayed out.

In S1015, the scan transmission application 222 switches the processing depending on an operation of the user on the save setting screen 900. In the case where the check box 914 is changed from the checked state to the unchecked state and the OK button 915 is pressed, in S1015, the scan transmission application 222 determines that an operation of changing the “save setting” of the currently-executed scan transmission application from enabled to disabled is performed. In this case, the scan transmission application 222 causes the processing to proceed to S516.

In S516, the scan transmission application 222 updates the setting values of the scan transmission application 222 stored in the RAM 103 to the initial values. Then, the processing proceeds to S517.

In S517, the scan transmission application 222 updates the setting values of the scan transmission application 222 stored in the HDD 105 to the initial values. Then, the processing proceeds to S1018.

In S1018, the scan transmission application 222 updates the value of the “save setting” of the scan transmission application stored in the RAM 103 to a value indicating the contents changed by the user through the save setting screen 900. Specifically, in the case where the check box 914 is checked and the OK button 915 is pressed, the value of the “save setting” of the scan transmission application stored in the RAM 103 is updated to the value indicating enabled. In the case where the check box 914 is unchecked and the OK button 915 is pressed, the value of the “save setting” of the scan transmission application stored in the RAM 103 is updated to the value indicating disabled. Then, the processing proceeds to S1019.

In S1019, the scan transmission application 222 updates the value of the “save setting” of the scan transmission application stored in the HDD 105, to the value indicating the contents selected by the user in the save setting screen 900. Specifically, in the case where the check box 914 is checked and the OK button 915 is pressed, the value of the “save setting” of the scan transmission application stored in the HDD 105 is updated to the value indicating enabled. In the case where the check box 914 is unchecked and the OK button 915 is pressed, the value of the “save setting” of the scan transmission application stored in the HDD 105 is updated to the value indicating disabled. In the case where S1019 is completed, the processing returns to S508.

Meanwhile, in the case where the check box 914 of the save setting screen 900 is changed from the unchecked state to the checked state and the OK button 915 is pressed, in S1015, the scan transmission application 222 determines that an operation of changing the “save setting” of the currently-executed application from disabled to enabled is performed. In this case, S516 and S517 are skipped, and the processes of S1018 and S1019 are executed.

Moreover, in the case where the OK button 915 is pressed without the pressing of the check box 914, the scan transmission application 222 determines that the operation of changing the “save setting” is not performed in S515. In this case, the processing returns to S508.

According to the present embodiment, as explained above, whether to perform the operation of setting the setting values to the initial values or the operation of storing the setting values of the current job to automatically set the setting values in the next job can be registered for each application. Accordingly, in the present embodiment, usability of the image forming apparatus can be further improved.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-017109, filed Feb. 7, 2024, which is hereby incorporated by reference herein in its entirety.

What is claimed is:

1. An image forming apparatus configured to execute a job corresponding to an application, the image forming apparatus comprising:
a display control unit configured to display, in initial activation of the image forming apparatus, a first screen for a user to select whether to enable a save setting or not, the save setting being a setting in which, in a case where a user changes a setting value relating to the job, the changed setting value is stored in a nonvolatile storage unit; and
a setting unit configured to automatically perform a setting of the job corresponding to the application based on the setting value stored in the storage unit and corresponding to the application in a case where the save setting is selected to be enabled.

2. The image forming apparatus according to claim 1, wherein
in a case where the application is selected by the user, the setting unit automatically performs the setting of the job if the save setting is selected to be enabled.

3. The image forming apparatus according to claim 1, further comprising
a storage control unit configured to, in a case where the save setting is selected to be enabled and the user changes the setting value relating to the job corresponding to the application in execution of the job, store the changed setting value in the storage unit in association with the application.

4. The image forming apparatus according to claim 1, wherein
the setting unit automatically performs the setting of the job based on an initial value in a case where the save setting is selected to be disabled.

5. The image forming apparatus according to claim 1, further comprising
a second display control unit configured to display a second screen that allows the user to change the setting value of the job corresponding to the application to instruct execution of the job, wherein
the changed setting value is a setting value changed by the user through the second screen.

6. The image forming apparatus according to claim 5, wherein
the second screen is displayed based on the setting value set by the setting unit in a case where the user selects the application.

7. The image forming apparatus according to claim 5, wherein
the second screen includes a button for transition to the first screen.

8. The image forming apparatus according to claim 1, wherein
the image forming apparatus is an image forming apparatus configured to execute the job corresponding to an application selected from among a plurality of the applications, and
the first screen is a screen in which the user selects whether to enable the save setting or not for each of the plurality of applications.

9. The image forming apparatus according to claim 8, further comprising
a storage control unit configured to, in a case where the save setting of the selected application is selected to be enabled and the user changes the setting value of the job corresponding to the selected application, store the changed setting value in the storage unit in association with the selected application.

10. The image forming apparatus according to claim 8, wherein,
in a case where the application is selected from the plurality of applications, the setting unit determines whether the save setting of the selected application is enabled, and
in the case where the setting unit determines that the save setting is enabled, automatically performs the setting of the job corresponding to the selected application based on the setting value associated with the selected application among the setting values stored in the storage unit.

11. The image forming apparatus according to claim 1, further comprising
a determination unit configured to determine that, when an operation of activation is performed, the activation is the initial activation in a case where a value of a flag is a first value,
wherein, the display control unit displays the first screen in a case where the determination unit determines that the activation is the initial activation, and
the value of the flag is the first value at shipping or after an initialization operation, and the value of the flag is changed to a second value in a case where contents of the save setting selected by the user through the first screen are stored.

12. The image forming apparatus according to claim 1, further comprising
a scanner, wherein
the application is an application configured to execute a job of transmitting scanned image data obtained by causing the scanner to scan an original.

13. The image forming apparatus according to claim 1, wherein
the change of the setting value of the job by the user is received without authentication of the user.

14. The image forming apparatus according to claim 1, wherein
the initial activation of the image forming apparatus is first activation after shipping.

15. A control method of an image forming apparatus configured to execute a job corresponding to an application, the method comprising:
displaying, in initial activation of the image forming apparatus, a first screen for a user to select whether to enable a save setting or not, the save setting being a setting in which, in a case where a user changes a setting value relating to the job, the changed setting value is stored in a nonvolatile storage unit; and
automatically performing a setting of the job corresponding to the application based on the setting value stored in the storage unit and corresponding to the application in a case where the save setting is selected to be enabled.

16. A non-transitory computer readable storage medium storing a program which causes a computer to perform a control method of an image forming apparatus configured to execute a job corresponding to an application, the method comprising:
displaying, in initial activation of the image forming apparatus, a first screen for a user to select whether to enable a save setting or not, the save setting being a setting in which, in a case where a user changes a setting value relating to the job, the changed setting value is stored in a nonvolatile storage unit; and
automatically performing a setting of the job corresponding to the application based on the setting value stored in the storage unit and corresponding to the application in a case where the save setting is selected to be enabled.
